(19) United States
(12) Patent Application Publication
(10) Pub. No.: US 2014/0214663 A1
(43) Pub. Date: Jul. 31, 2014

(54) SYSTEM AND METHOD FOR LOCATION-BASED DELIVERY OF DISCOUNTED PREPAID GIFT ACCOUNTS OFFERS

(71) Applicant: GIFTCARDS.COM, LLC, (US)

(72) Inventor: Jason WOLFE, Sewickley, PA (US)

(73) Assignee: GIFTCARDS.COM, LLC, Pittsburgh, PA (US)

(21) Appl. No.: 13/754,452

(22) Filed: Jan. 30, 2013

(51) Int. Cl. G06Q 30/06; G06Q 20/34

(52) U.S. Cl. CPC G06Q 30/06; G06Q 20/351
USPC 705/41

(57) ABSTRACT

Delivery of offers to sell discounted prepaid gift accounts in the secondary prepaid gift account marketplace to consumers present at retail point of sale location is disclosed. The system receives information from a mobile device while a user is at a retail location. The system communicates with a database of discounted prepaid gift accounts to identify a discounted prepaid gift account. The system sends an offer to sell a selected discounted prepaid gift account to the device while the user is at the location. If the user accepts the offer to purchase the discounted prepaid gift account, the system accepts payment from the user via the device for the prepaid gift accounts. Upon receipt of payment, the system transmits information regarding the purchased prepaid gift accounts to the device enabling the user to use the prepaid gift account to make a purchase.

### BACKGROUND

1. Technical Field

The present disclosure relates to the location-based delivery of offers to sell discounted prepaid gift accounts and more specifically to delivery of an offer to sell a discounted prepaid gift account to a user when such user is present at a retail location enabling such user to purchase the discounted prepaid gift account via a mobile computing device and immediately use such prepaid gift account to make a purchase at the retail location.

2. Introduction

Prepaid gift accounts are widely used as gifts for birthdays, Christmas, holidays or other reasons. Prepaid gift accounts can be issued as physical cards. A prepaid gift account can also be issued as an account number delivered to the prepaid account holder via text message, email or as data displayed on an application residing on a mobile computing device such as a mobile telecommunications device, a mobile computing device such as a laptop computer, smart phone or tablet computer or a non-mobile computer device such as a personal computer system, personal gaming system or satellite or cable television system. Prepaid gift accounts can be closed loop, meaning that the value represented by the prepaid gift account is a valid form of payment at a closed set of retailers. For example, an OUTBACK STEAKHOUSE® prepaid gift account is only redeemable at OUTBACK STEAKHOUSE® and not at PLANET HOLLYWOOD® or TARGET®. Some closed loop prepaid gift accounts are valid at a family of closely related or commonly owned merchants. For example, a DARDEN RESTAURANTS prepaid gift account is valid at RED LOBSTER® and OLIVE GARDEN®; similarly, a local mall prepaid gift account is valid at tenant merchants in the local mall. By contrast, prepaid gift accounts can also be open loop, such as VISA® or MASTERCARD® debit cards, which serve as a valid form of payment at virtually any retailer nationwide.

While prepaid gift accounts are popular alternatives to cash and merchandise gifts, such prepaid gift accounts typically have various limitations which reduce their utility and appeal to the recipient. For example, the recipient may have trouble redeeming the prepaid gift account due to geographic limitations associated with the prepaid gift account. Many times, the prepaid gift account is tied to a particular merchant which the recipient may dislike, greatly reducing the value of the prepaid gift account to the recipient. Many prepaid gift account holders forget to bring the prepaid gift account card with them when shopping and sometimes even forget that they own the prepaid gift account card. According to one estimate, consumers purchase about $80 billion worth of prepaid gift accounts annually in the U.S., and roughly 10%, or $8 billion, of that amount goes unredeemed. Thus, consumers waste these unredeemed funds and do not benefit from the full value of the prepaid gift account. Further, if these funds are not spent, they can escheat to the state.

Due to these limitations and restrictions, a robust secondary market has also developed for the resale of previously issued and used prepaid gift accounts at a discount to the value in such prepaid gift account. A discounted prepaid gift account is a prepaid gift account offered for sale at a price less than the current dollar value of the prepaid gift account. A discounted prepaid account can be a newly issued prepaid gift account or a previously issued and partially spent prepaid gift account. An example of a newly issued prepaid gift account would be a $100 Target® gift card is offered for sale to a consumer for $85.00. An example of a previously issued and partially spent prepaid gift account would be a $100 Target® gift card originally issued at a value of $100.00 to a recipient, partially spent by the originally recipient so that only $50.00 of value remains on the prepaid gift account, and then offered for resale to a consumer for $35.00. Consumers typically purchase discounted prepaid gift accounts from online providers which specialize in the resale of discounted prepaid gift accounts. However, discounted prepaid gift accounts are typically not available for purchase at brick and mortar retail locations.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can provide a secure and efficient mechanism for delivery of offers to sell a discounted prepaid gift account in the secondary prepaid gift account marketplace to a consumer present at a retail point of sale location or at any location. More specifically, the principles disclosed herein allow a user the ability to purchase a discounted prepaid gift account while present at a retail location and immediately utilize the purchased discounted prepaid gift account to make a purchase of goods/services from the merchant at such retail location. The principles could also apply to on-line purchases, rather than brick and mortar stores.

Disclosed are systems and methods for delivery of offers to sell a discounted prepaid gift account in the secondary prepaid gift account marketplace to a consumer present at retail point of sale location or at another location. The system receives position information from a user's mobile computing device while such user is present at a retail location, based on the position information, the system communicates with a database of discounted prepaid gift accounts to identify one or more discounted prepaid gift accounts which can be used to make purchases at the retail location wherein the user is present, the system selects from such database one or more discounted prepaid gift accounts which can be used to make purchases at the retail location wherein the user is present. The system sends an offer to sell one or more discounted prepaid gift accounts to the user's mobile computing device while the user is present at the retail location (or present at any particular spot, even at home at a personal computer). If the user accepts the offer to purchase the discounted prepaid gift accounts, the system accepts payment from the user via the user's mobile computing device for one or more prepaid gift accounts. Upon receipt of payment, the system transmits information regarding the purchased prepaid gift account to the user's mobile computing device enabling the user to use the prepaid gift account to make a purchase at the retailer or in another fashion.

In one embodiment, the information regarding the one or more purchased prepaid gift accounts is transmitted to the user's mobile computing device via one of a text message and an email which contains the prepaid gift account numbers or other data and structure to enable the transaction. The system could also transmit the information regarding the one or more purchased prepaid gift accounts to and display the information on the user's mobile computing device in an application in one of a numerical prepaid gift account number, QR code and a barcode.

The location information could be automatically transmitted by an application residing on such user's mobile computing device based on the location of the user's mobile computing device. The location information could be manually transmitted by the user via the user's mobile computing device. The user could pay for the purchase of the prepaid gift account using one of a credit card, debit card, PayPal® and an ACH transfer or a preexisting payment method on file with the service bureau.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates a multi-process secure gateway configuration;

FIG. 3 illustrates a user interaction with a secure gateway; and

FIG. 4 illustrates an exemplary method for delivery of discounted prepaid gift accounts to a user present at a retail location.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

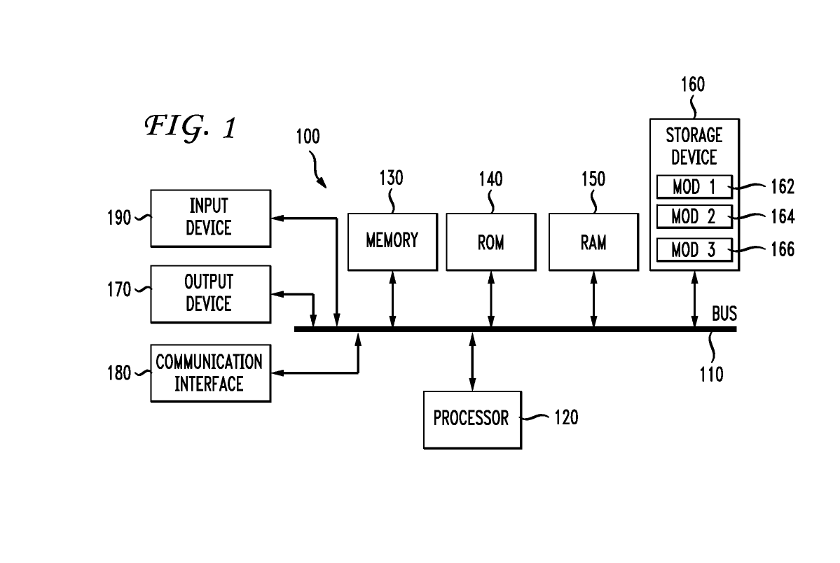

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. These and other modules can be configured to control the processor 120 to perform various actions. Other system memory 130 may be available for use as well. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a tangible and/or intangible computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. The input device 190 may be used by the presenter to indicate the beginning of a speech search query. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Generally speaking, such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

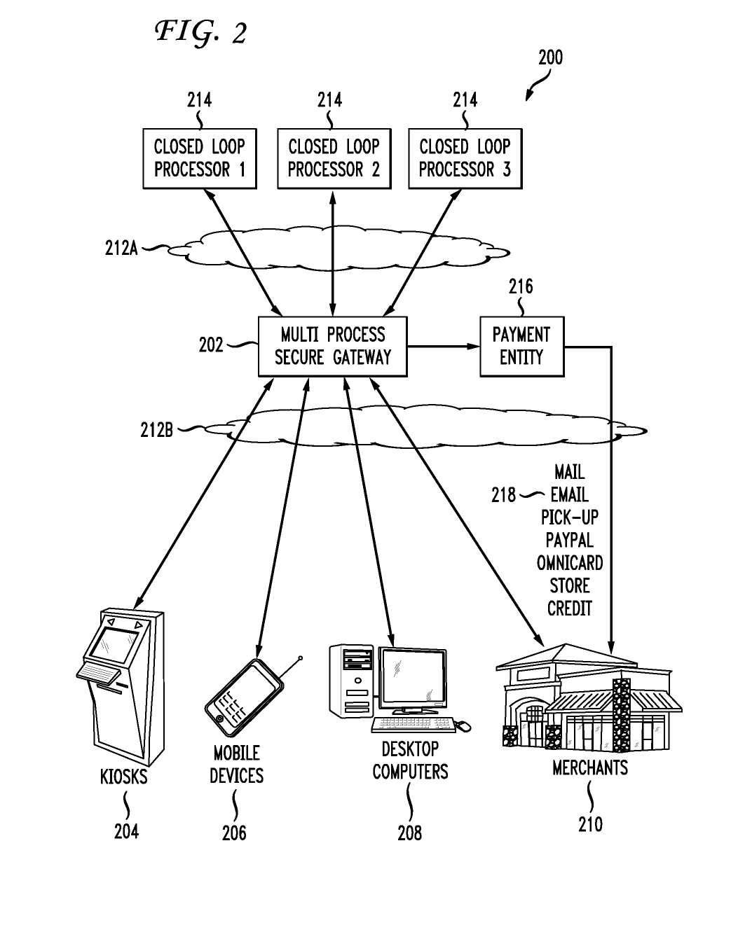

Having disclosed some components of a computing system, the disclosure now turns to a discussion of prepaid gift accounts, followed by a description of the exemplary multi-process secure gateway configuration shown in FIG. 2. A more detailed discussion of transmitting offers to sell prepaid gift accounts to a user presently at a retail location (or other location) will then follow.

Prepaid gift accounts are divided into open loop and closed loop prepaid gifts. Typically, issuing banks or credit card companies issue open loop prepaid gift accounts (example: VISA, MASTERCARD, AMEX or DISCOVER) which can be redeemed by virtually any business entity. Open loop accounts differ from closed loop prepaid gift accounts which are typically issued by a specific store or restaurant and can be only redeemed by the issuing provider (example: SEARS, RED LOBSTER, TARGET). Prepaid gift accounts can be issued as open loop or closed loop physical cards or as an account number delivered (or the information associated with the account is delivered) to the prepaid account holder or to some other person or device via text message, email or as data displayed on an application residing on a mobile computing device such as a mobile telecommunications device, a mobile computing device such as a laptop computer, smart phone or tablet computer or a non-mobile computer device such as a personal computer system, personal gaming system or satellite or cable television system. Information associated with the accounts can be delivered in any fashion as noted above.

The disclosure now turns to FIG. 2, which illustrates a multi-process secure gateway configuration 200. The multi-process secure gateway 202 can be implemented as a local or remote server, a group of tightly or loosely interconnected servers, integrated as a software module within a point of sale device, or as any other suitable device, software, or combination thereof. In FIG. 2, the multi-process secure gateway 202 is shown as a single conceptual server available over a network 212B, such as the public telephone network or the Internet. The principles set forth herein can be applied to local area networks, wide area networks, virtual private networks, intranets, home networks, corporate networks, wireless ad-hoc networks, peer-to-peer networks, and virtually any other form of network.

The multi-process secure gateway 202 interacts with various requesters, such as kiosks 204, mobile devices 206, desktop computers 208, and merchants' point of sale devices 210, which submit information uniquely identifying prepaid gift accounts associated with prepaid gifts. Mobile computing device 204 can be a device with Wi-Fi or wireless communications capability including a laptop computer, tablet computer such as an iPad or any other tablet computing device, an iPod, iPhones, Samsung Galaxy, or smartphone. Each of these devices can interact with the secure gateway 202 through different protocols, such as a direct network connection, cellular connection, an HTTP-based portal, SMS messages, telephone, interactive voice response systems, point-of-sale (POS) terminals, browsers, plugs-ins, Secure Shell, File Transfer Protocol, Internet Protocol, Simple Mail Transfer Protocol, Telnet, etc.

In the case of merchants, each point of sale of the merchant 210 can connect to a centralized merchant server (not shown) which relays requests to the secure gateway 202 on behalf of all the merchant 210 point of sale devices.

The secure gateway 202 interacts with multiple closed loop processors 214, such as FIRSTDATA and CHASE PAYMENTECH, over a network 212A such as the Internet or other appropriate network. These processors are entities that process prepaid gift accounts. An example processor is FIRSTDATA, which differs from a computer processor such as an AMD PHENOM II or INTEL CORE DUO as would be known to one of skill in the art. The secure gateway 202 can perform any action on the prepaid gift account through the various prepaid gift account processors 214 as if the secure gateway 202 was a merchant. The secure gateway 202 analyzes the submitted information to determine which closed loop processor handles the respective type of prepaid gift account. For example, a particular series of numbers or letters can indicate that one prepaid gift account is honored by PAYMENTECH, and another distinct set of numbers or letters indicates that another closed loop card/code associated with an account is honored by FIRSTDATA. The logic and analysis in the secure gateway 202 can change from time to time as new types of prepaid gift account are issued by existing prepaid gift account processors 214 or as the secure gateway 202 adds interfaces for new prepaid gift account processors. The secure gateway 202 can include a common application programmer interface (API) which defines actions which may be performed through the prepaid gift account processors 214. The API translates API calls to the corresponding specific sets of proprietary interactions with the various closed loop processors 214, which may be very different between prepaid gift account processors 214.

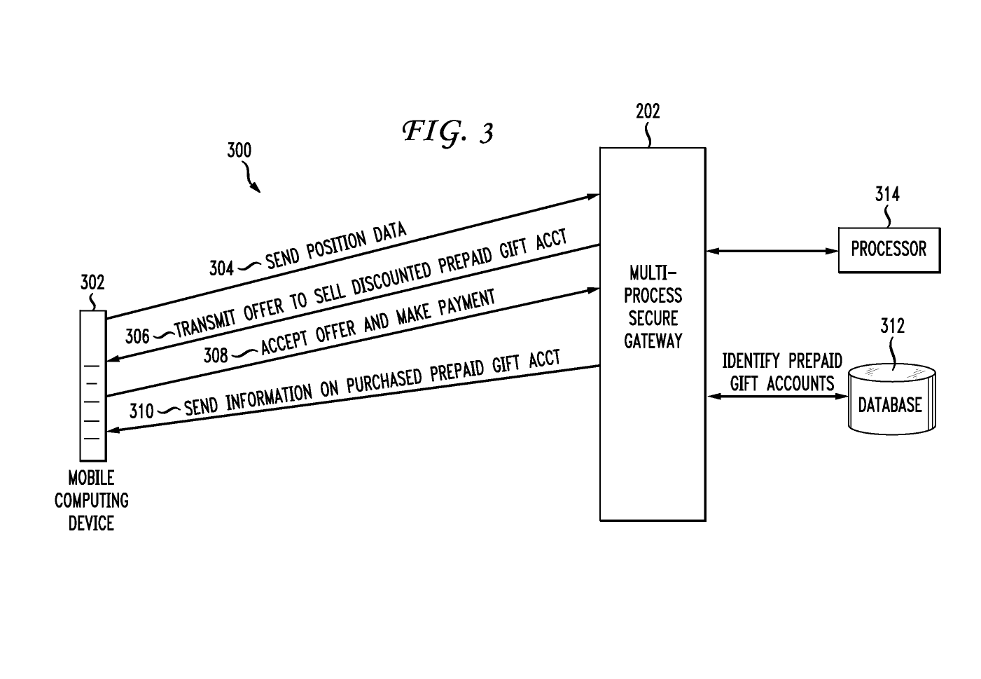

FIG. 3 illustrates a system 300 of one embodiment. As shown in FIG. 3, the secure gateway 202 receives position information 304 from a user's mobile computing device 302 while such user is present at a retail location or other specific location. The mobile computing device 302 can transmit the position information 304 to the secure gateway 202 automatically or the user can use the mobile computing device 302 to manually transmit the position information to the secure gateway 202. A retail location can be a single retailer or a plurality of retailers located in a single location such as a shopping mall. A location may be a person's home which can indicate that on-line purchases can be made. The secure gateway 202 then communicates with a database 312 containing an inventory of discounted prepaid gift accounts to identify and select one or more prepaid gift accounts which can be used to make purchases of at the retail location or other location where the user is present. The secure gateway 202 then transmits an offer 306 to sell the identified one or more discounted prepaid gift accounts to the user's mobile computing device 302. If the user accepts the offer to purchase the one or more discounted prepaid gift accounts, the secure gateway 202 accepts 308 the offer and payment from the user via the user's mobile computing device 302 and transmits information regarding the one or more purchased discounted prepaid gift accounts 310 to the user's mobile computing device (302). The user can pay for the purchase of the discounted prepaid gift account using a preexisting payment method on file with the service bureau operating the secure gateway or using one of a credit card, debit card, PayPal or an ACH transfer.

The information regarding the one or more purchased prepaid gift accounts can be transmitted 310 to the user's mobile computing device 302 via a text message or an email which contains the prepaid gift account number and instructions on how to use the account number to make purchases. The information regarding the one or more purchased discounted prepaid gift accounts can also be transmitted to the user's mobile computing device 302 and displayed on the mobile computing device in an application as a numerical account number, a quick response (QR) code or a bar code accompanied by instructions on how to make purchases at the retail location.

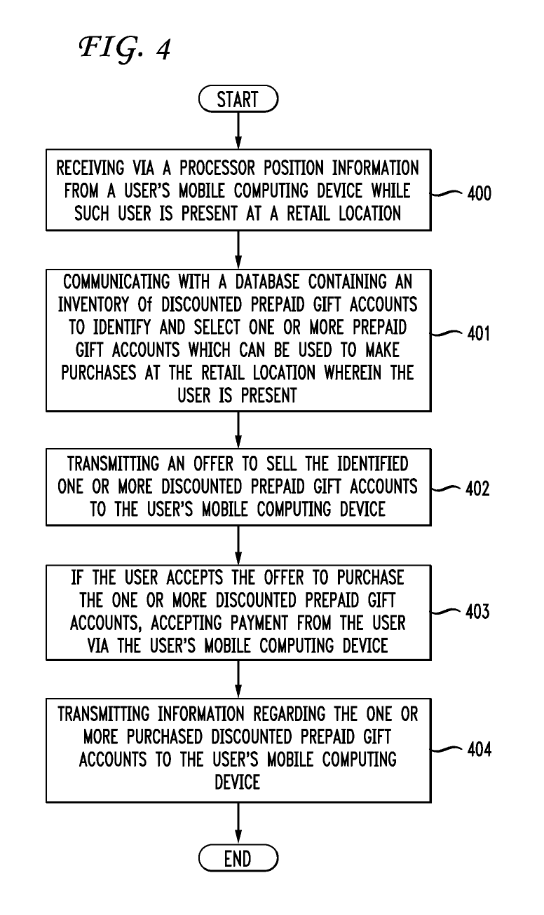

Having disclosed some basic system components and concepts, the disclosure now turns to the exemplary method embodiments shown in FIG. 4. For the sake of clarity, the methods are discussed in terms of an exemplary system 100, as shown in FIG. 1, configured to practice the methods. The steps outlined herein are exemplary and can be implemented in any combination thereof, including combinations that exclude, add, or modify certain steps.

FIG. 4 illustrates an exemplary method for delivering offers to sell discounted prepaid gift accounts to a user present at a retail location. The method can be practiced by a system 100, as shown in FIG. 1, a compute cluster, a server farm, or any other multi node configuration. The system first receives position information from a user's mobile computing device while such user is present at a retail location (400). The system then communicates with a database containing an inventory of discounted prepaid gift accounts to identify and select one or more prepaid gift accounts which can be used to make purchases of at the location wherein the user is present (401). The system then transmits an offer to sell the identified one or more discounted prepaid gift accounts to the user's mobile computing device (402). If the user accepts the offer to purchase the one or more discounted prepaid gift accounts, the system then accepts payment from the user via the user's mobile computing device (403) and transmits information regarding the one or more purchased discounted prepaid gift accounts to the user's mobile computing device (404). The system then prompts the user to pay for the purchase of the discounted prepaid gift account using a preexisting payment method on file with the service bureau operating the system or using one of a credit card, debit card, PayPal or an ACH transfer.

Embodiments within the scope of the present disclosure may also include tangible computer-readable storage media for carrying or having computer-executable instructions or data structures stored thereon. Such computer-readable storage media can be any available media that can be accessed by a general purpose or special purpose computer, including the functional design of any special purpose processor as discussed above. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving, via a processor, position information from a user's mobile computing device while such user is present at a location;
communicating with a database containing an inventory of discounted prepaid gift accounts to identify a discounted prepaid gift account which can be used to make a purchase at the location;
selecting, based on the position information, from such database the discounted prepaid gift account;
transmitting an offer to sell the discounted prepaid gift account to the user's mobile computing device while the user is present at the location;
if the user accepts the offer to purchase the discounted prepaid gift account, accepting payment from the user via the user's mobile computing device to yield a purchased prepaid gift account; and
transmitting information regarding the purchased prepaid gift account to the user's mobile computing device.

2. The method of claim 1, wherein the information regarding the purchased prepaid gift account is transmitted to the user's mobile computing device via one of a text message and an email.

3. The method of claim 1, wherein the information regarding the purchased prepaid gift account is transmitted to the user's mobile computing device and displayed on the user's mobile computing device in an application in one of a numerical prepaid gift account number, QR code and a barcode.

4. The method of claim 1, wherein the location information is automatically transmitted by an application residing on the user's mobile computing device based on the location.

5. The method of claim 1, wherein the location information is manually transmitted by the user via the user's mobile computing device.

6. The method of claim 1, wherein the user pays for the purchase of the prepaid gift account using one of a credit card, debit card, prepaid gift account, PayPal and ACH transfer.

7. The method of claim 1, wherein the user pays for the purchase of the prepaid gift account using a preexisting payment method on file with the service provider.

8. A system comprising:
a processor; and
a computer-readable medium storing instructions which, when executed by the processor, cause the processor to perform a method comprising:
receiving, via a processor, position information from a user's mobile computing device while such user is present at a location;
communicating with a database containing an inventory of discounted prepaid gift accounts to identify a discounted prepaid gift account which can be used to make a purchase at the location;
selecting, based on the position information, from such database the discounted prepaid gift account;
transmitting an offer to sell the discounted prepaid gift account to the user's mobile computing device while the user is present at the location;
if the user accepts the offer to purchase the discounted prepaid gift account, accepting payment from the user via the user's mobile computing device to yield a purchased prepaid gift account; and
transmitting information regarding the purchased prepaid gift account to the user's mobile computing device.

9. The system of claim 8, wherein the prepaid gift account information is transmitted to the user's mobile computing device via one of a text message and an email.

10. The system of claim 8, wherein the prepaid gift account information is transmitted to the user's mobile computing device and displayed on the user's mobile computing device in an application in one of a numerical prepaid gift account number, a OR code and a barcode.

11. The system of claim 8, wherein the location information is automatically transmitted by an application residing on the user's mobile computing device based on the location.

12. The system of claim 8, wherein the location information is manually transmitted by the user via the user's mobile computing device.

13. The system of claim 8, wherein the user pays for the purchase of the prepaid gift account using one of a credit card, debit card, prepaid gift account, PayPal and ACH transfer.

14. The system of claim 8, wherein the user pays for the purchase of the prepaid gift account using a preexisting payment method on file with the service provider.

15. A computer-readable storage medium storing instructions which, when executed by the processor, cause the processor to perform a method comprising:
receiving, via a processor, position information from a user's mobile computing device while such user is present at a location;
communicating with a database containing an inventory of discounted prepaid gift accounts to identify a discounted prepaid gift account which can be used to make a purchase at the location;
selecting, based on the position information, from such database the discounted prepaid gift account;
transmitting an offer to sell the discounted prepaid gift account to the user's mobile computing device while the user is present at the location;
if the user accepts the offer to purchase the discounted prepaid gift account, accepting payment from the user via the user's mobile computing device to yield a purchased prepaid gift account; and
transmitting information regarding the purchased prepaid gift account to the user's mobile computing device.

16. The computer-readable medium of claim 15, wherein the information regarding the purchased prepaid gift account is transmitted to the user's mobile computing device via one of a text message and an email.

17. The computer-readable medium of claim 15, wherein the information regarding the purchased prepaid gift account is transmitted to the user's mobile computing device and displayed on the user's mobile computing device in an application in one of a numerical prepaid gift account number, QR code and a barcode.

18. The computer-readable medium of claim 15, wherein the location information is automatically transmitted by an application residing on the user's mobile computing device based on the location.

19. The computer-readable medium of claim 15, wherein the location information is manually transmitted by the user via the user's mobile computing device.

20. The computer-readable medium of claim 15, wherein the user pays for the purchase of the prepaid gift account using one of a credit card, debit card, prepaid gift account, PayPal and ACH transfer.
